(19) United States
(12) Patent Application Publication
(10) Pub. No.: US 2002/0059214 A1
(43) Pub. Date: May 16, 2002

(54) User support system

(75) Inventors: Yasuo Shibusawa, Matsumoto (JP); Junji Suzuki, Shiojiri (JP); Hideki Makiyama, Matsumoto (JP); Toru Funamizu, Yamagata-mura (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/983,738

(22) Filed: Oct. 25, 2001

(30) Foreign Application Priority Data
Nov. 7, 2000 (JP) 2000-339388

(51) Int. Cl. G06F 7/00

(52) U.S. Cl. 707/3

(57) ABSTRACT

A user's computer 1 is a computer that a user purchases from a manufacturer. The computer 1, a host computer 3 for the manufacturer that sold the computer 1 to provides a support service, and a terminal unit 4 operated by a person in charge of support are connected to a network 2. A storage unit 5 in the host computer 3 stores a database for user support. This database includes the specifications 11 of computer at the time it is purchased, installed software 12, information 13 on the condition of a trouble that occurred, information 14 on a troubleshooting measure, information 15 on the content of a repair request, and information on the progress of repair processing. All of information which is usable for computer support can be viewed by a user and a service person, and a prompt and appropriate support can be performed. Also, the condition of repair can be checked in real time.

### BACKGROUND OF THE INVENTION

1. Field of Invention

The present invention relates to a user support system for executing support responsive to the handling of goods such as sold computers and to troubles that occurred.

2. Description of Related Art

When selling computers, a sales company needs to establish a support system responsive to various queries from users. In the case of computers, users have various problems in operation of hardware and software, a technique for coping with trouble, etc. The users each make a telephone call to a person in charge of support about the problems, and query the person about the operation and measures. A computer manufacturer has staffs having various skills, such as not only a staff for support about elementary operation techniques but also a staff capable of responding to technical and high-level queries, and responds to users' queries by telephone, e-mail, and fax. At the same time, the manufacturer is equipped with a detailed manual for responding to various troubles, and the support person deals with the users with reference to the manual. Computers are incorporated into many types of goods such as electrical household products, and operations thereof become complicated, so that an increased number of troubles occur. Accordingly, it is required for a manufacturer providing such goods to have a more improved support system.

### SUMMARY OF THE INVENTION

The above related art has the following problems to be solved.

For simple questions occurring when operating the computer, troubles caused by misoperations, troubles due to complex cause in connection with hardware and software, etc., improvement of the support system is in great demand as the computer becomes complex, the performance of hardware becomes advanced, and the level of provided software becomes higher.

However, in a period in which computers are used by various users, from users who have sufficient knowledge of computer, to users who seldom touch computers, there is a possibility that a service deteriorates since a support system responsive to queries is insufficient. For example, situations occur in which a user cannot get through to the support person no matter how often the user calls, and in which there is an insufficient number of persons who have knowledge capable of appropriately responding to troubles when users query them.

Accordingly, concerning troubles that frequently occur, a technique is employed in which measures therefor are displayed in the form of a Q&A list in a homepage on the Internet. Nevertheless, even if these are referred to, there is not a small number of problems that cannot be solved. Also, in a case in which many types of computers are treated, troubleshooting methods differ depending on the types. In the case of computers, various components as options may be provided by users themselves. In general, the computers are provided with various application programs. Therefore, troubles that cannot be expected by the support person may occur, which increasingly complicates the problem. The establishment of a support system for appropriately responding to such points is in demand.

If not only the support system for selling computers but also a support system used for selling various types of goods is bad, sales promotion is not expected. Conversely, an extra support system greatly increases costs.

To solve the foregoing points, the present invention employs the following constructions.

### Construction 1

A user support system comprising: a database in which information representing the specifications of a computer at the time a user purchases the computer, software which is added or changed after the purchase, and the condition of a trouble occurring after the purchase are recorded; and a terminal unit for searching and referring to the database.

By preparing a database that stores the specifications of a user's computer at the time it is purchased, software which is added and changed after the purchase, and the condition of troubles that occurred after the purchase, and setting the database so that it can be searched, the pursuit of the status of the user's computer and a cause of occurrence of trouble, and considerations of measures are facilitated. The terminal unit may be an arbitrary device that can be operated by at least a support person. By including, in the database, all of data which represents trouble conditions having occurred after the purchase of the computer, a continuous support can be performed.

### Construction 2

A user support system comprising: a database in which information representing the specifications of a computer at the time a user purchases the computer, hardware which is added or changed after the purchase, and the condition of a trouble occurring after the purchase are recorded; and a terminal unit for searching and referring to the database.

Also in the case of adding and changing the hardware, support similar to the above is preferable.

### Construction 3

A user support system comprising: a database in which information representing the specifications of a computer at the time a user purchases the computer, software which is added or changed after the purchase, hardware which is added or changed after the purchase, and the condition of a trouble occurring after the purchase are recorded; and a terminal unit for searching and referring to the database.

Support in view of both software and hardware is most preferable.

### Construction 4

A user support system database characterized in that in a user support system as set forth in any of Constructions 1 to 3, the database includes information representing a troubleshooting method answered in response to a trouble posted from the user.

By including, in this database, also the troubleshooting method shown to the user, a transfer of duties between support persons is smoothed.

### Construction 5

A user support system as set forth in any of Constructions 1 to 3, wherein the database includes web data which is stored in a storage unit of a host computer linked to a user terminal unit by a network and which can be referred to in retrieval by the user terminal unit.

By referring to the database by using the user's terminal unit, the user can know a troubleshooting method unique to the user's computer with reference to past cases. Accordingly, queries to the support person decrease.

### Construction 6

A user support system as set forth in any of Constructions 1 to 3, wherein the database contains a set of web pages which are accessed based on the serial number of a user apparatus.

By accessing a web page based on a serial number according to the user, usability to the user improves and the support person easily searches the database.

### Construction 7

A user support system as set forth in any of Constructions 1 to 3, wherein the database includes information representing a repair request from a user and information representing the progress of repair processing in response to the repair request.

By displaying the repair request and the progress of the repair processing in response to the repair request, it is possible to cope with an inquiry from a customer.

### Construction 8

A user support system as set forth in Construction 7, wherein the information representing the progress of the repair processing is displayed on a web page accessible by a user terminal unit, and in the web page, a button for accessing a person in charge of repair is displayed.

If there is the button for accessing the repair person, inquiry processing in a case in which the condition of the repair processing is recognized on the web page and a further question raises is simplified.

### Construction 9

A user support system as set forth in Construction 8, wherein the button is a button for making a telephone call to the person.

### Construction 10

A user support system as set forth in Construction 8, wherein the button is a button for sending mail to the person.

### Construction 11

A user support system as set forth in Construction 5, wherein the database contains a set of web pages which are stored in the storage unit of the host computer linked to the user terminal unit by the network.

### Construction 12

A user support system as set forth in Construction 5, wherein the URL of the web page is displayed in a user-support data file stored in the storage unit of a computer of the user.

### Construction 13

A user support system as set forth in Construction 5, wherein the URL of the web page is displayed in a user-support data file stored in a driver-data recording medium distributed with a computer of the user.

### Construction 14

A user support system comprising: a database in which information representing the specifications of goods at the time a user purchases the goods and information representing the condition of a trouble occurring after the purchase are recorded; and a terminal unit for searching and referring to the database.

By preparing a database storing trouble conditions that occurred after the purchase of not only computers but also various types of goods, and setting the database so that it can be searched, the pursuit of a cause of trouble and consideration of measures are facilitated. By including, in the database, all of data which represents trouble conditions having occurred after the purchase of the goods, a continuous support can be performed.

### Construction 15

A user support system as set forth in Construction 14, wherein the database includes information representing a troubleshooting method answered in response to a trouble posted from the user.

### Construction 16

A user support system as set forth in Construction 15, wherein the database includes web data which is stored in a storage unit of a host computer linked to a user terminal unit by a network and which can be referred to in retrieval by the user terminal unit.

### Construction 17

A user support system as set forth in Construction 16, wherein the database includes web data stored in a storage unit of a host computer linked to a user terminal by a network and which is written after retrieval by the user terminal.

In the database, not only information heard from the user, but also information declared by direct writing of the user is included. By allowing the user to directly write addition and change of hardware or software in the database, more careful service can be provided.

### BRIEF DESCRIPTION OF THE DRAWINGS

FIG. 1 is a block diagram showing a specific example of a user support system of the present invention.

FIG. 2 is a block diagram of a system for including in a database the specification of a computer at the time it is purchased.

FIG. 3 is a specific illustration of a user support page.

FIG. 4 shows an example of a user support page for coping with repair-request processing.

FIG. 5 is a flowchart of a specific process in the case of using a user support system of the present invention.

FIG. 6 is an illustration of a modification of a user support page.

### DETAILED DESCRIPTION OF PREFERRED EMBODIMENTS

Embodiments of the present invention are described below, using specific cases.

In the following cases, a support system in a case in which a computer is sold is exemplified.

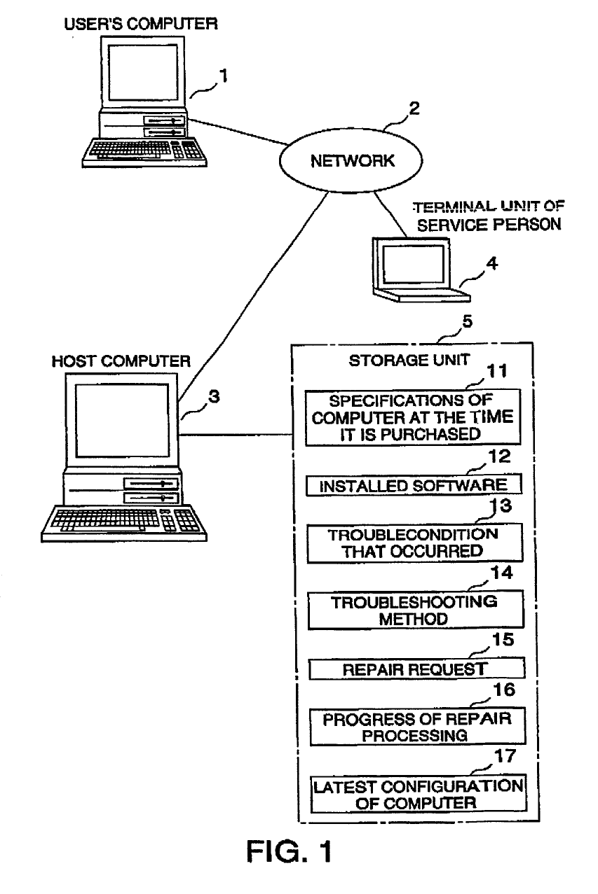

FIG. 1 is a block diagram showing a specific example of a user support system of the present invention.

It is assumed that a user's computer 1 shown in this figure is a computer purchased from a manufacturer by the user. This computer is treated as what to be supported. The computer 1 is connected to a network 2. A host computer 3 for allowing the manufacturer which sold the computer 1 to provide a support service is also connected to the network 2.

Also a terminal unit 4 which is operated by a person in charge of support is connected to the network 2. A storage unit 5 in the host computer 3 stores a database for user support. This database includes the specifications 11 of the computer at the time it is purchased, installed software 12, information 13 representing the condition of a trouble that occurred, information 14 representing a troubleshooting method, information 15 representing the content of a repair request, information 16 representing the progress of repair processing, and a latest computer configuration 17.

The host computer 3, the user's computer 1, and the terminal unit 4 of the service person can search the database stored in the storage unit 5 and can refer to various types of information. The specifications 11 of the computer at the time it is purchased are information indicating what hardware configuration the computer had when the user purchased the computer 1. Such information is very important since troubles that may occur and measures thereto differ depending on each computer model. Similarly, in a case in which computer hardware is added or changed, the latest computer configuration 17 is important information.

In addition, the installed software 12 is information containing a list of, not only those at the time the computer was purchased, but also, for example, application programs that the user purchased as options and installed, and software that the user independently purchased and installed. Such information is effective since troubles that may occur differ depending on the type of installed software.

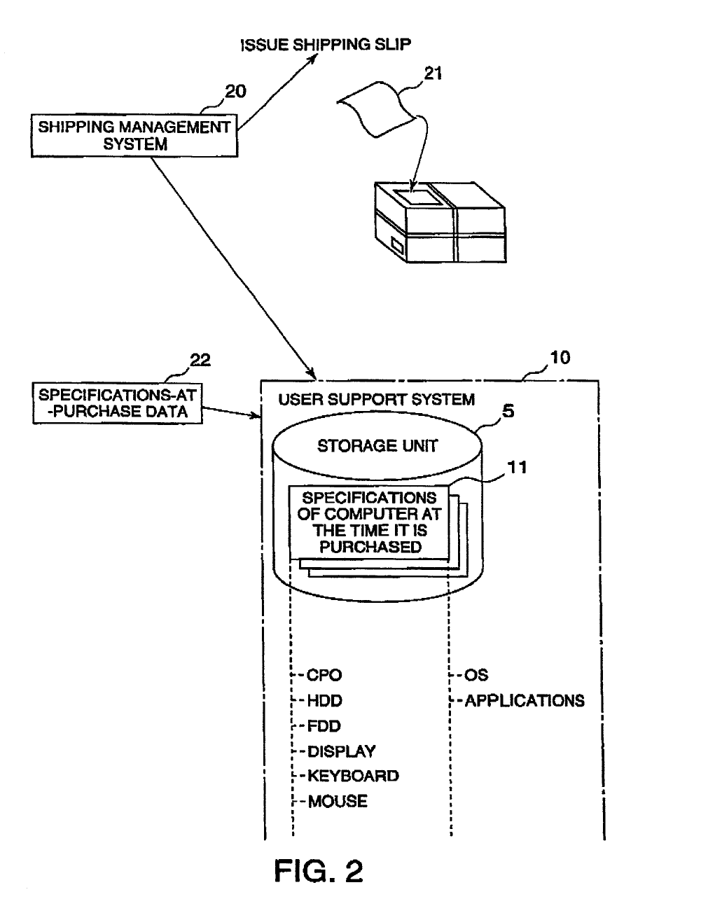

FIG. 2 is a block diagram of a system for including in the database the specifications of the computer at the time it is purchased.

As shown in FIG. 2, when the computer purchased by the user is shipped to the user, a shipping management system 20 issues a shipping slip 21. Then, in the shipping slip 21, a computer model and part of the specifications are written. The shipping management system 20 retains information on detailed computer specifications. This information is called specifications-at-purchase data 22. The shipping management system 20 automatically outputs the specifications-at-purchase data 22 to a user support system 10 when performing shipping.

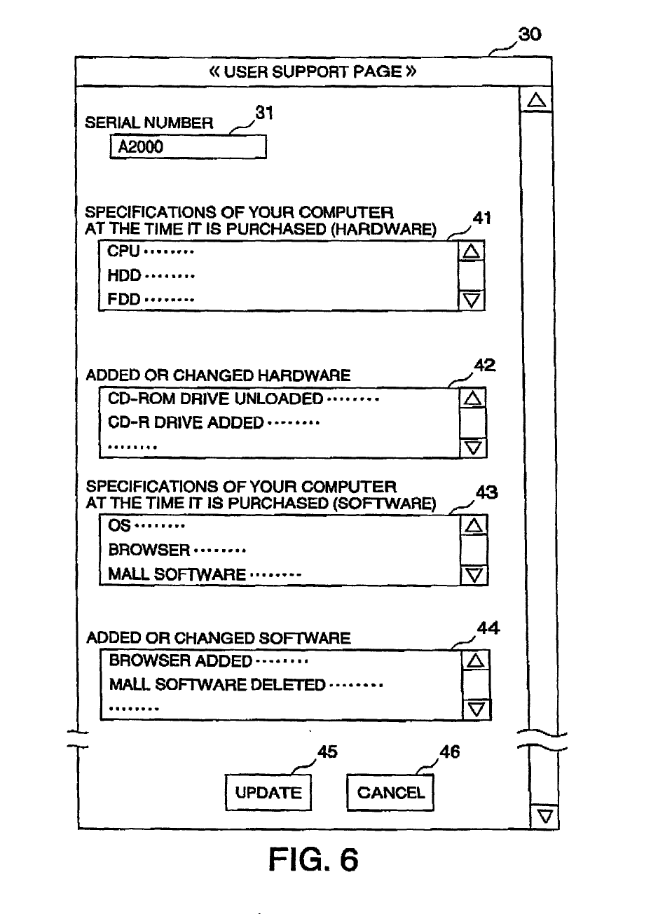

The user support system 10 receives and stores the data as the specifications 11 of computer at the time it is purchased. In this one, a configuration of hardware, for example, a CPU, an HDD, a FDD, a display, a keyboard, and a mouse is fully recorded. An OS, the types of application programs, etc., are also recorded. In this manner, the specifications 11 are generated when the computer is shipped to the user. The latest computer configuration 17 is input by querying the user at a repair request. Alternatively, it is input by the user himself or herself, as described later using FIG. 6.

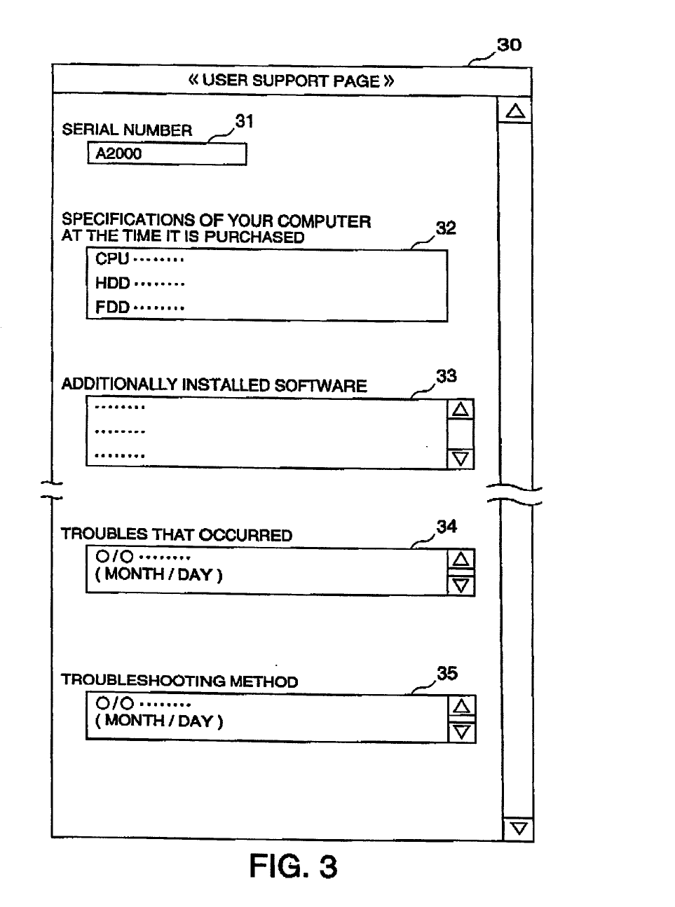

FIG. 3 is a specific illustration of a user support page.

The host computer 3 in FIG. 1 provides the user support page 30 shown in FIG. 3 which can be viewed by operating the user's computer 1. The user support page 30 is used not only for being viewed by the user when a trouble occurs in the computer, but also for allowing the user to input various types of information.

By way of example, in the installed software shown in FIG. 1, software that the user independently purchased and installed in the computer cannot be recognized in its original form on the side of the host computer 3. Accordingly, based on information obtained from the user, information on the installed software 12 is stored in the storage unit 5. For that, a system is provided which allows the user to voluntarily input information to the user support page 30 shown in FIG. 3. Specifically, as shown in FIG. 3, in the user support page 30, five text boxes 31, 32, 33, 34, and 35 are provided in this example. For example, by installing an additional software diagnosis tool into the user's computer, a history of addition and deletion of software after the purchase can be automatically recorded. This record may be transferred to the user support page. A serial number in the text box 31 is a portion displaying a key for opening the user support page 30. This user support page can be viewed only by a user who has a computer corresponding to the serial number.

In the text box 32, the specifications of the computer at the time it is purchased are displayed. These are, as described above, written from the time the user purchased the computer, and are displayed from the beginning on the user support page 30. In the text box 33, additionally installed software is displayed. Software installed at the purchase may be simultaneously displayed here. The user may open the user support page 30 and may enter software additionally installed in the user's computer 1 each time. This operation is described later using FIG. 6.

This makes it possible to indicate what application program the user's computer has and in what condition the user's computer is. When the user purchases new software as an option from the manufacturer from which the user purchased the computer, the manufacturer side may automatically input the name of the software into the text box 33.

Next, a case in which the user encounters some trouble and queries the manufacturer about a measure thereto is described. In this case, after opening the user support page 30, the content of the trouble that occurred is entered in the text box 34. The case shown in this figure requests the user to enter what trouble occurred in which month on which day, otherwise the form of expression is free.

As described, after entering the trouble occurring to the computer in the text box 34, clicking on a transmission button, which is not shown, transmits, to the service person, mail which requests a reply about measures to the trouble. After receiving the mail, the service person opens the user support page 30 and enters a necessary answer in the text box 35 for inputting a troubleshooting method. While inputting the answer, the service person simultaneously uses mail to prompt the user to view the user support page 30.

Alternatively, after entering, in the mail, detailed measures to the trouble that occurred, the answer is sent. The content of the answer must be recorded in the user support page 30. Accordingly, in the user support page 30, troubles that occurred in the computer purchased by the user, and troubleshooting measures thereto are all recorded as a history. Such a trouble may occur repeatedly. The user does not always accurately remember the troubleshooting measures to the troubles that occurred. By viewing the user support page 30, which measure solved this problem in the past is clarified if a trouble occurs which is identical to one that occurred in the past, so that the need for querying the service person again is eliminated.

In addition, when the service person is queried about measures to a trouble which is very similar to a trouble that occurred in the past, the service person can give an appropriate advice with reference to past examples. There is also a case in which such troubles and measures data can be used in unchanged form for a response to another user. In particular, by considering a troubleshooting measure with reference to the user support page 30, which displays all such as the specifications of the computer and additionally installed software, a more appropriate advice can be given. Also, by responding by mail directly using the content of a record on the user support page 30, special operations are not required and the load on the service person can be reduced. In other words, compared with the case of responding by telephone case by case, support services for a much larger number of users can be smoothed.

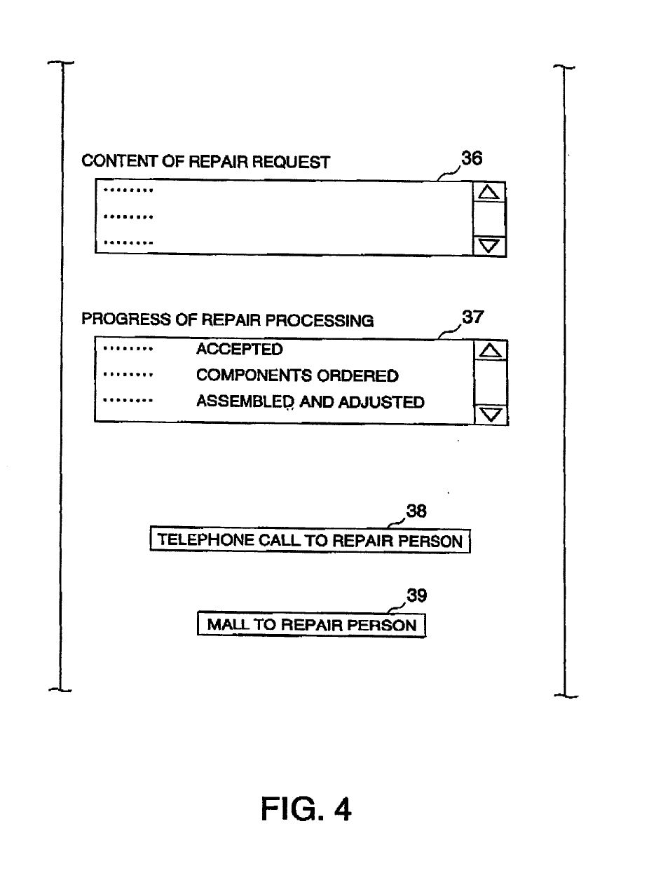

FIG. 4 shows an example of a user support page for responding to repair-request processing.

This user support page 30 is provided with text boxes 36 and 37 into which the content of a repair request and the progress of repair processing can be input. Also, a button 38 for automatically making a telephone call to a repair person, and a button 39 for transmitting mail to the repair person are provided. This is a record of a repair request when the user sent the computer to the manufacturer and made the repair request.

Accordingly, the content of the repair request is entered by the manufacturer so that it confirms the content. The content is displayed in the text box 36. How much repair processing for the repair request is developed is displayed in the text box 37 indicating the progress of the repair processing. This text box displays, for example, information such as on what date the repair request was accepted, on what date components were ordered, and on what date assembly and adjustment were performed. With this, the user can open the user support page 30 and fully understand, in real time, what condition the repair processing on the computer is in after the repair request was made.

As a result, the number of times the user queries about when the computer for which the user makes the repair request is sent back decreases, so that the load on the service person is reduced. Also, the user has an advantage in having no stress since the user can always grasp the repair condition. However, when there is a problem that cannot be solved by simply displaying the progress of the repair processing, the button 38 for automatically making a telephone call to the repair person and the button 39 for transmitting mail to the repair person are used. By clicking on the button 38, the user's computer automatically calls the repair person, and the user can have a conversation with the repair person. By clicking on the button 39 for the mail to the repair person, a mail-creating window is started, and the user enters a query, etc., in mail and transmits the mail. This makes it possible to receive a reply to the mail from the repair person.

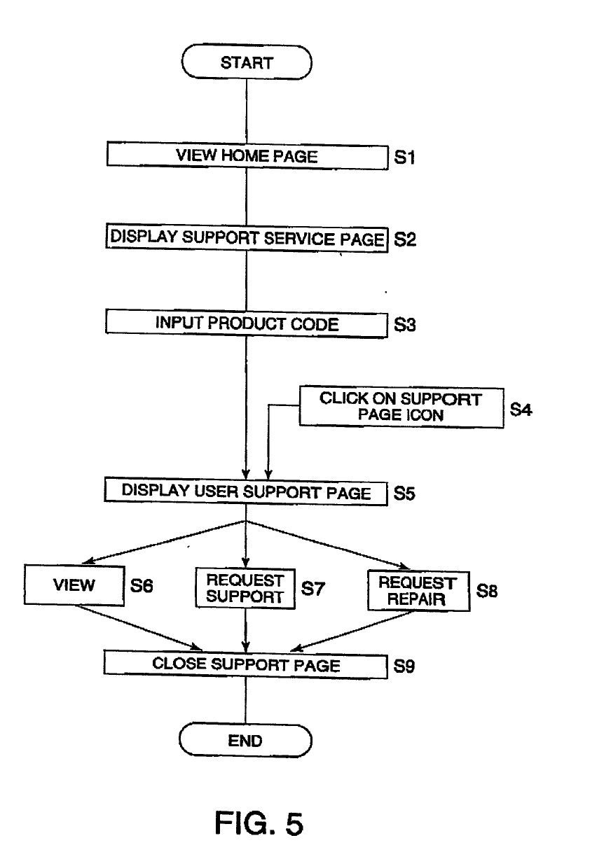

FIG. 5 is a specific process flowchart for the case of using a user support system of the present invention.

At first, when the user wishes to view the user support page, the user views the manufacturer's homepage (step S1). The user controls the page of a support service to be displayed (step S2). Here, the user inputs the serial number of the user's computer (step S3). This displays a support page for each user, specifically, the user support page 30 shown in FIG. 3 (step S5). However, by setting, for example, a support service icon in the user's computer 1, and clicking on the icon, the support page for each user can be directly displayed.

In this case, in the processing of step S4, the computer transmits the serial number to the host computer. After that, the process proceeds to step S5, and the support page 30 can be opened immediately. Here, the user executes any one of whether to simply view the support page (step S6), whether to input a support request (step S7), and whether to make a repair request (step S8). After that, the support page is closed (step 9). In this manner, the user can receive various services by using the support page.

In the above example, a case in which the service person considers and inputs a troubleshooting measure for the user has been described. By using a knowledge database so that a computer automatically derives measures and enters the result in the support page, the user can acquire a troubleshooting measure in real time by performing an interaction with the computer, and an improvement in the user service can be achieved.

FIG. 6 is an illustration of a modification of the user support page.

On this user support page, a text box 31 for inputting the serial number of the user's computer is provided similarly to the user support page described using FIG. 3. Also, a text box 41 is provided which shows the specifications of the user's computer at the time it is purchased. The text box 41 displays the hardware specifications of the computer at the time it is purchased.

In the next text box 42, the contents of added and changed hardware are displayed. For example, when a CD-ROM drive is changed to a CD-R drive, specific specifications thereof are displayed. In a text box 43, the software specifications of the computer at the time it is purchased are displayed. In the next text box 44, the contents of added and changed software are displayed. For example, when a browser is additionally installed, its specific software name, etc., are displayed.

In this specific example, the contents of the text boxes 42 and 44 can be input mainly by the user. For improving the operability, an update button 45 and a cancel button 46 are provided. For example, after inputting the name of newly added hardware in the text box 42, clicking on the update button 45 updates the contents of the database. Also, clicking on the cancel button 46 leads an initial state obtained before data is input.

As described above, by clarifying the status of both software and hardware, a more appropriate support service can be performed. In the case of support dedicated to the hardware, it is not necessary to provide a section for displaying a change in the software. By allowing the user to write freely in the user support page, the user can make use of the user support page for the user's computer. In addition, there is an advantage in that an appropriate service is possible without recognizing by the service side the latest status of software and hardware for each time.

In the above description, the present invention has been discussed exemplifying a support system for a computer. However, the present invention can be used as support systems for various types of goods. When there are predetermined unique numbers and symbols for specifying sold goods, the user uses the Internet to easily acquire specific information on a support for the goods. By providing a system in which defects having occurred to the goods in the past, and information on support therefor are displayed and may be viewed, the system is very useful for both the user and a person in charge of support.

In addition, when a component of goods is exchanged at a repair of the goods, by including information on the exchanged component, measures for repair can be made based on specifications obtained after the exchange. From the above points, a system is realized which is optimized for repairing trouble unique to each type of goods.

What is claimed is:

1. A user support system comprising:
a database in which information representing the specifications of a computer of a user at the time the computer is purchased, software which is added or changed after the purchase, and the condition of a trouble occurring after the purchase are recorded; and
a terminal unit for searching and referring to said database.

2. A user support system comprising:
a database in which information representing the specifications of a computer of a user at the time the computer is purchased, hardware which is added or changed after the purchase, and the condition of a trouble occurring after the purchase are recorded; and
a terminal unit for searching and referring to said database.

3. A user support system comprising:
a database in which information representing the specifications of a computer of a user at the time the computer is purchased, software which is added or changed after the purchase, hardware which is added or changed after the purchase, and the condition of a trouble occurring after the purchase are recorded; and
a terminal unit for searching and referring to said database.

4. A user support system database characterized in that in a user support system as set forth in any of claim 1 to claim 3, said database includes information representing a troubleshooting method answered in response to a trouble posted from said user.

5. A user support system as set forth in any of claim 1 to claim 3,
wherein said database includes web data which is stored in a storage unit of a host computer linked to a user terminal unit by a network and which can be referred to in retrieval by said user terminal unit.

6. A user support system as set forth in any of claim 1 to claim 3,
wherein said database contains a set of web pages which are accessed based on the serial number of a user apparatus.

7. A user support system as set forth in any of claim 1 to claim 3,
wherein said database includes information representing a repair request from a user and information representing the progress of repair processing in response to said repair request.

8. A user support system as set forth in claim 7, wherein:
said information representing the progress of the repair processing is displayed on a web page accessible by a user terminal unit; and
in the web page, a button for accessing a person in charge of repair is displayed.

9. A user support system as set forth in claim 8,
wherein the button is a button for making a telephone call to the person in charge of repair.

10. A user support system as set forth in claim 8,
wherein the button is a button for sending mail to the person in charge of repair.

11. A user support system as set forth in claim 5,
wherein said database contains a set of web pages which are stored in the storage unit of said host computer linked to said user terminal unit by said network.

12. A user support system as set forth in claim 5,
wherein the URL of said web page is displayed in a user-support data file stored in the storage unit of a computer of the user.

13. A user support system as set forth in claim 5,
wherein the URL of said web page is displayed in a user-support data file stored in a driver-data recording medium distributed with a computer of the user.

14. A user support system comprising:
a database in which information representing the specifications of goods at the time a user purchases said goods and information representing the condition of a trouble occurring after the purchase are recorded; and
a terminal unit for searching and referring to said database.

15. A user support system as set forth in claim 14,
wherein said database includes information representing a troubleshooting method answered in response to a trouble posted from said user.

16. A user support system as set forth in claim 15,
wherein said database includes web data which is stored in a storage unit of a host computer linked to a user terminal unit by a network and which can be referred to in retrieval by said user terminal unit.

17. A user support system as set forth in claim 16,
wherein said database includes web data stored in a storage unit of a host computer linked to a user terminal by a network and which is written after retrieval by said user terminal.
